(19) United States
(12) Patent Application Publication
(10) Pub. No.: US 2025/0028562 A1
(43) Pub. Date: Jan. 23, 2025

(54) AUTO SCALING METHOD AND DEVICE CONSIDERING APPLICATION SERVICE RESPONSE TIME

(71) Applicant: FOUNDATION OF SOONGSIL UNIVERSITY-INDUSTRY COOPERATION, Seoul (KR)

(72) Inventors: Young Han KIM, Seoul (KR); Tae Hoon KIM, Seoul (KR)

(21) Appl. No.: 18/432,433

(22) Filed: Feb. 5, 2024

(30) Foreign Application Priority Data
Jul. 19, 2023 (KR) 10-2023-0093970

(51) Int. Cl. G06F 9/50; G06F 11/34

(52) U.S. Cl. CPC G06F 9/5027; G06F 9/5072; G06F 11/3409; G06F 2209/504

(57) ABSTRACT

An auto scaling device includes a processor; and a memory connected to the processor, wherein the memory stores program instructions executed by the processor to restrict resources of pods distributed according to setting of an initial resource quota in a name space, collect a monitoring metric of an application for which service is requested, determine whether to change a resource quota by using the collected monitoring metric, a recent data reflection rate of a service predetermined in a custom resource, a service level agreement (SLA) of a service, and an SLA threshold when the resources of the pods are insufficient, and update an initial resource quota in the name space to a first resource quota when the change of the resource quota is required.

### CROSS-REFERENCE TO RELATED APPLICATION

This application claims priority under 35 U.S.C. § 119(a) to Korean Patent Application No. 10-2023-0093970 filed in the Korean Intellectual Property Office on Jul. 19, 2023, the entire contents of which are incorporated herein by reference.

### BACKGROUND

### (a) Technical Field

The present disclosure relates to a method and a device for auto scaling considering an application service response time, and more particularly, to a method and a device for allocating and managing resources of a Kubernetes cluster.

### (b) Background Art

Multiple tenant support of a Kubernetes cluster is made through a name space (NS).

That is, an NS resource quota (CPU, memory) is allocated, and horizontal pod autoscaling of a pod is performed within a given resource quota.

Distribution of a new pod and scaling by the HPA are possible only in the resource quota of the NS.

However, currently, there is no function to dynamically adjust the Kubernetes resource quota.

Currently, when additional distribution of the pod becomes impossible, an error message is generated, and as a result, separate resource quota scaling is performed by an administrator.

In resource quota setting in a Kubernetes based cloud, it is difficult to find a determination ground of an appropriate resource quota, so an application error or resource can be wasted due to wrong quota setting.

In addition, in related art, if scaling is performed immediately when an error message is generated or a threshold is exceeded, due to lack of flexibility, unnecessary additional allocation not considering traffic volatility can be made.

Therefore, a function to dynamically adjust an NS-specific resource quota size is required, and a flexible adjustment function is required by considering a service quality of each workload which is operated on the NS.

### SUMMARY OF THE DISCLOSURE

In order to solve the problem in the related art, it is an object of the present disclosure to provide a method and a device for auto scaling considering an application service response time, which may efficiently perform resource allocation by delaying scaling as much as possible at a level that does not violate a service quality of an application.

In order to achieve the above object, according to an embodiment of the present disclosure, provided is an auto scaling device including a processor; and a memory connected to the processor, wherein the memory stores program instructions executed by the processor to restrict resources of pods distributed according to setting of an initial resource quota in a name space, collect a monitoring metric of an application for which service is requested, determine whether to change a resource quota by using the collected monitoring metric, a recent data reflection rate of a service predetermined in a custom resource, a service level agreement (SLA) of a service, and an SLA threshold when the resources of the pods are insufficient, and update an initial resource quota in the name space to a first resource quota when the change of the resource quota is required.

The program instructions may calculate a calculation value of the response time of the application by using the collected monitoring metric and the recent data reflection rate at a predetermined cycle.

The recent data reflection rate may be classified into multiple levels.

The recent data reflection rate may be classified into immediate, moderate, slow, and very slow in order of high recent data reflection rate.

The program instructions may determine that the initial resource quota is updated to the first resource quota when an alarm is generated due to the insufficient resources of the pods, and the calculation value of the response time calculated through a predetermined prediction model exceeds a result of summing up the SLA and a value acquired by multiplying the SLA by the SLA threshold.

The calculation value of the response time may be a weighted moving average of the response time calculated by using an exponential weighted moving average (EWMA) model at a predetermined cycle.

The weighted moving average of the response time may be calculated by an equation below:

$${\overline{x}}_{k} = α {\overline{x}}_{k - 1} + ( 1 - α ) {x}_{{k}_{( 0 < α < 1 )}} \qquad [ Equation ]$$

wherein, xₖ represent a current response time, x̅ₖ₋₁ represents a moving average value up to a previous sample, α represent the recent data reflection rate, and x̅ₖ represents a weighted moving average up to a current sample.

Computing resource information of the pods may be collected through a metric server, and the computing resource information may include a target CPU utilization, the number of currently distributed pods, and a CPU usage of a current pod.

The first resource quota may be calculated by an equation below:

$$cur Quota = reqPods * ceil \{ ( cur Utilization Val - curHPA ) * cPods \} \qquad [ Equation ]$$

wherein, curQuota represents a resource quota value updated by the auto scaling, reqPods represents a requested CPU specification of application pods, curUtilizaionVal represents a CPU usage of a current pod, curHPA represents a target CPU utilization of the HPA, and cPods represents the number of currently distributed pods.

The program instructions may update the first resource quota to the initial resource quota again when a pod error is removed due to the update to the first resource quota.

According to another embodiment of the present disclosure, provided is an auto scaling device including a processor; and a memory connected to the processor, wherein the memory stores program instructions executed by the processor to restrict resources of pods distributed according to setting of an initial resource quota in a name space, collect a monitoring metric of an application for which service is requested, and delay scaling by using at least one of the collected monitoring metric, a recent data reflection rate of a service predetermined in a custom resource, a service level agreement (SLA) of a service, and an SLA threshold when the resources of the pods are insufficient.

According to yet another embodiment of the present disclosure, provided is an auto scaling system considering an application service response time including: a cluster manager restricting resources of pods distributed according to setting of an initial resource quota in a name space; an application monitoring unit collecting a monitoring metric of an application for which service is requested; and a custom scaling controller determining whether to change a resource quota by using the collected monitoring metric, a recent data reflection rate of a service predetermined in a custom resource, a service level agreement (SLA) of a service, and an SLA threshold when the resources of the pods are insufficient, and updating an initial resource quota in the name space to a first resource quota when the change of the resource quota is required.

According to still yet another embodiment of the present disclosure, provided is an auto scaling method considering an application service response time in a device including a processor and a memory, which includes: restricting resources of pods distributed according to setting of an initial resource quota in a name space; collecting a monitoring metric of an application for which service is requested; determining whether to change a resource quota by using the collected monitoring metric, a recent data reflection rate of a service predetermined in a custom resource, a service level agreement (SLA) of a service, and an SLA threshold when the resources of the pods are insufficient; and updating an initial resource quota in the name space to a first resource quota when the change of the resource quota is required.

According to the present disclosure, there is an advantage in that efficient resource allocation is possible by delaying scaling as much as possible at a level that does not violate a service quality of an application by considering temporary traffic increase for an application when a resource quota of a name space is insufficient.

### BRIEF DESCRIPTION OF THE DRAWINGS

FIG. 1 is a diagram illustrating a configuration of an auto scaling system according to an embodiment of the present disclosure.

FIG. 2 is a diagram illustrating a pseudo code for updating a resource quota according to an embodiment of the present disclosure.

FIGS. 3 to 4 are diagrams illustrating tracking results in different services.

FIGS. 5 to 6 are diagrams illustrating a result of applying auto scaling according to an embodiment to different services.

### DETAILED DESCRIPTION

The present disclosure may be embodied in various modifications and have various embodiments, so specific embodiments will be illustrated in the drawings and described in detail in the detailed description. However, this does not limit the present disclosure to specific exemplary embodiments, and it should be understood that the present disclosure covers all the modifications, equivalents and replacements included within the idea and technical scope of the present disclosure.

The terms used in the present specification are used only to describe specific embodiments, and are not intended to limit the present disclosure. A singular form includes a plural form unless the context clearly dictates otherwise. In this specification, it should be understood that the term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

In addition, the components of the embodiment described with reference to each drawing are not limitedly applied only to the corresponding embodiment, and may be implemented to be included in another embodiment within the scope of maintaining the technical idea of the present disclosure, and further, even if a separate explanation is omitted, it is natural that a plurality of embodiments may also be re-implemented as one integrated embodiment.

In addition, in the description with reference to the accompanying drawings, the same components are assigned the same or related reference numerals regardless of the reference numerals, and redundant descriptions thereof will be omitted. In describing the present disclosure, a detailed description of related known technologies will be omitted if it is determined that they unnecessarily make the gist of the present disclosure unclear.

An embodiment provides an auto scaling method based on a service quality and horizontal pod autoscaler (HPA) target utilization of an application.

According to an embodiment of the present disclosure, a resource quota of a name space on Kubernetes is set, and metric server setting and application performance measurement and monitoring for triggering a scaling task are performed.

To this end, it is assumed that it is possible to extend an application distributed to a Kubernetes cluster by an HPA, and it is assumed that a service level agreement (SLA) of a service distributed by a provider is a response time of the application, and a range of a desired service level is known.

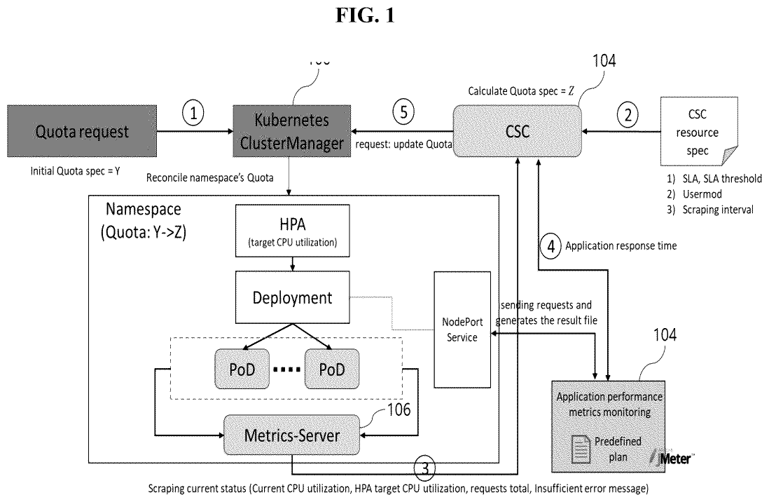

FIG. 1 is a diagram illustrating a configuration of an auto scaling system according to an embodiment of the present disclosure.

Referring to FIG. 1, the auto scaling system according to the embodiment may include a cluster manager 100, an application monitoring unit 102, and a custom scaling controller 104.

An initial quota (Initial quota spec=Y) of the name space is applied to the cluster manager 100, and the cluster manager 100 distributes a pod according to the initial resource quota, and performs scaling by the HPA.

Resources of pods distributed according to the initial resource quota are limited by the cluster manager 100.

The HPA operates by a scheme of generating or deleting the number of pods according to a demand of a workload.

A metric server 106 in the name space collects computing resource information (resource usage) of pods included in the name space, and delivers the collected computing resource information to the custom scaling controller 104.

The computing resource information may include a current CPU utilization, the current number of pods, a requested CPU specification of application pods, an HPA target CPU utilization, all requests, and an insufficient resource error message.

The application monitoring unit 102 pools an application monitoring metric which is being executed in the name space at a predetermined time interval, and stores the application monitoring metric through a predefined file.

Here, the monitoring metric may include a past response time and a current response time of an application for which service is requested.

The custom scaling controller 104 determines whether to change the resource quota by using a recent data reflection rate of the service and the service level agreement (SLA) and an SLA threshold of the service defined in the custom resource when the resources of the pods are insufficient, that is, when an alarm is generated due to the insufficient resources of the pods, and updates the initial resource quota in the name space to a first resource quota when the resource quota needs to be changed.

Here, the recent data reflection rate may be defined as a reflection rate of the past and current response time. According to an embodiment of the present disclosure, the application monitoring metric collected by the application monitoring unit 102 is delivered to the custom scaling controller 104 at a predetermined time interval, and the custom scaling controller 104 calculates a calculation value of an application response time through a predetermined prediction model, and determines to update the initial resource quota to the first resource quota when the calculated calculation value of the response time exceeds a value of summing up the SLA and a value acquired by multiplying the SLA by the SLA threshold.

As described above, the information stored in the custom resource may include the SLA, the SLA threshold, the recent data reflection rate (Usermode) of the service, and a data scraping interval.

According to an embodiment of the present disclosure, when an “Insufficient CPU” error of the pod occurs, that is, when a requested quantity of pods>Namespace Resource Quota, an option to select a scaling time based on the application response time is provided from the viewpoint of the provider through Usermode.

Here, Usermode as the recent data reflection rate may be defined as a weight which allows resource allocation to be efficiently performed by delaying scaling at a level that does not violate the service quality as much as possible, and expressed as in a table below.

TABLE 1

| | |
|---|---|
| Immediate | Immediate scaling upon occurrence of pod error due to quota |
| | limitation |
| Moderate | Changing real-time scaling time by reducing recent data |
| | refection rate compared to immediate setting by 50% |
| Slow | Changing real-time scaling time by reducing recent data |
| | refection rate compared to immediate setting by 90% |
| Very Slow | Changing real-time scaling time by reducing recent data |
| | refection rate compared to immediate setting by 99% |

According to an embodiment of the present disclosure, a prediction model according to the embodiment may utilize an exponential weighted moving average (EWMA) model as in an equation below for dynamical scaling of the resource quota in the name space:

$${\overline{x}}_{k} = α {\overline{x}}_{k - 1} + ( 1 - α ) {x}_{{k}_{( 0 < α < 1 )}} \qquad [ Equation 1 ]$$

wherein, xₖ represents the current response time, x̅ₖ₋₁ represents a moving average value up to a previous sample, α represents the recent data reflection rate, and x̅ₖ represents a weighted moving average (calculation value) up to a current sample.

In Table 1, the recent data reflection rate may be variously transformed, and the Usermode may be classified into multiple levels according to the recent data reflection rate.

The multiple levels may be classified into immediate, moderate, slow, and very slow in order of the highest recent data reflection rate, but this is just described as an example, and is not necessarily limited thereto.

Immediate (α=0) reflects only recent data, and is defined as being scaled immediately when an “Insufficient CPU” error of the pod occurs due to the resource quota limitation.

Moderate (α=0.5) is defined as calculating the weighted moving average of the response time by reducing the recent data reflection rate compared to immediate setting, that is, significantly increasing the past data reflection rate, and Slow (α=0.9) is defined as a policy for the user to sufficiently utilize system resources according to traffic which is changed by more significantly reducing the recent data reflection rate.

Very slow (α=0.99) is a policy for controlling the scaling time according to a past trend line rather than recent traffic by reflecting all past data.

When a pod error occurs due to the resource quota, the custom scaling controller 104 determines whether to update the resource quota based on the weighted moving average, the SLA, and the SLA threshold of the response time calculated by using the Usermode set for the application for which service is currently requested.

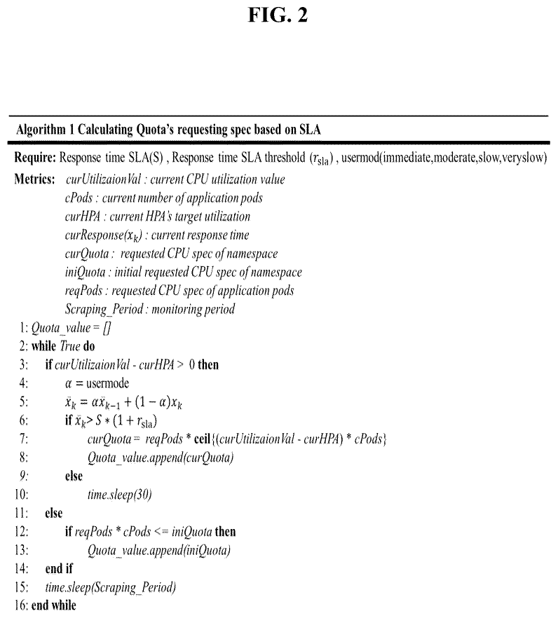

FIG. 2 is a diagram illustrating a pseudo code for updating a resource quota according to an embodiment of the present disclosure.

Whether to update the resource quota may be determined through an equation below:

$${\overline{x}}_{k} > S * ( 1 + {r}_{sla} ) \qquad [ Equation 2 ]$$

wherein, S represents the response time SLA and rₛₗₐ represents the response time SLA threshold.

As in Equation 2, the custom scaling controller 104 determines that the initial resource quota is updated to the first resource quota when an alarm is generated due to the insufficient resources of the pods, and a weighted moving average of the response time calculated through a predetermined prediction model exceeds a result of summing up the SLA and the value acquired by multiplying the SLA by the SLA threshold.

When it is determined that the update of the resource quota is required, the custom scaling controller 104 determines a resource quota value to be updated through an equation below:

$$cur Quota = reqPods * ceil \{ ( cur Utilization Val - curHPA ) * cPods \} \qquad [ Equation 3 ]$$

wherein, curQuota represents a resource quota value updated by the auto scaling, reqPods represents a requested CPU specification of application pods, curUtilizaionVal represents a CPU usage of a current pod, curHPA represents a target CPU utilization of the HPA, and cPods represents the number of currently distributed pods.

As described above, the pod error is removed by the update of the resource quota, and when reqPods*cPods<=iniQuota, the resource quota value returns to the iniQuota (initial resource quota) value which is initially set.

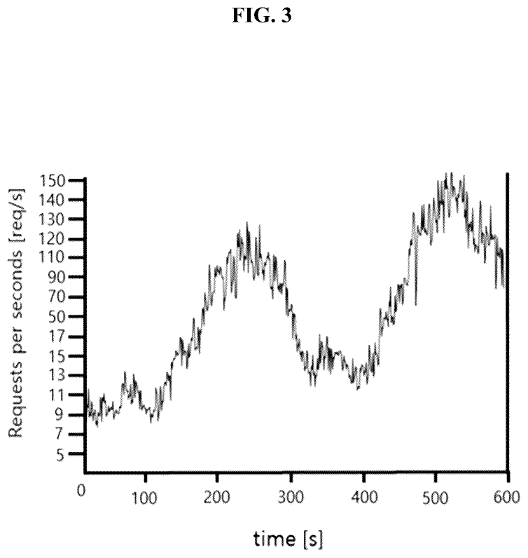

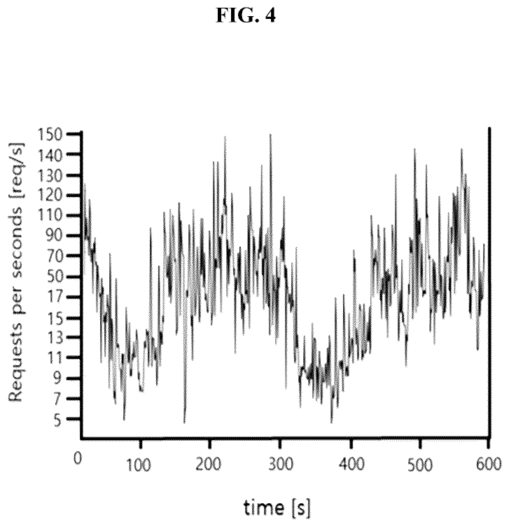

FIGS. 3 to 4 are diagrams illustrating tracking results in different services.

FIG. 3 relates to a Worldcup homepage access service, which is brought from two-day tracking information among values tracked and observed for 3 months, and is rectified according to an experimental environment.

As in FIG. 3, the World Cup homepage access service shows a clear seasonal tendency having a pole and a slope.

FIG. 4 relates to a NASA homepage access service, which is constituted by 2-day access logs, and is rectified according to an experimental environment.

As in FIG. 4, the NASA homepage access service shows rapid fluctuations in a workload.

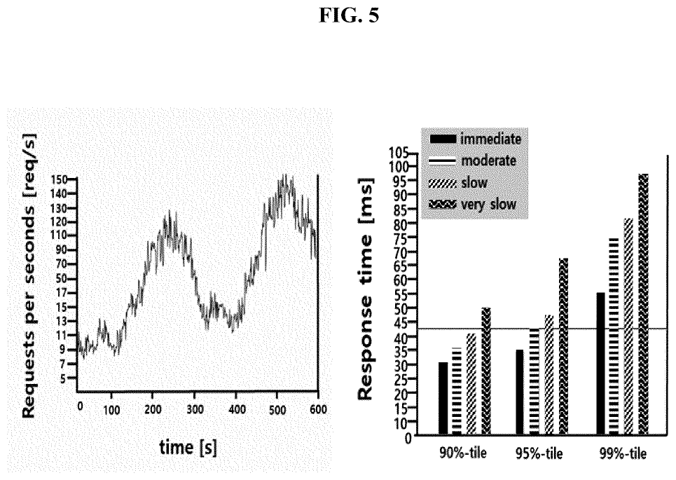

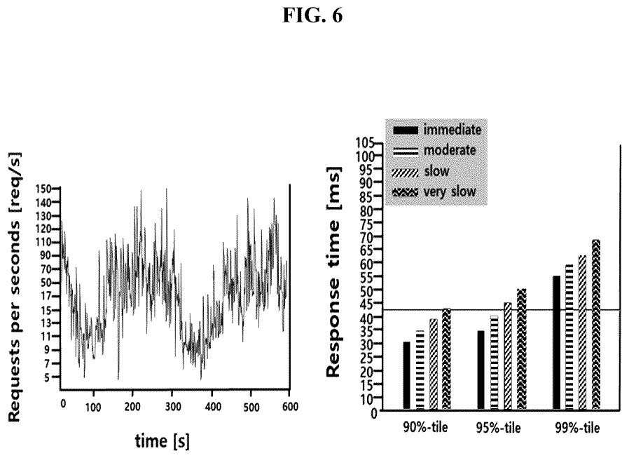

FIGS. 5 to 6 are diagrams illustrating a result of applying auto scaling according to an embodiment of the present disclosure to different services.

In FIGS. 5 to 6, it is assumed that the service level agreement is guaranteed in a 95%-tile interval, Response time SLA(S)=40 ms, and Response time SLA threshold (rₛₗₐ)=10%.

Referring to FIG. 5, the volatility is not large, and an effect is not large in a periodic traffic situation like a Worldcup trace, but a moderate setting value is below 95%-tile, and as a result, even though the resource quota is not immediately scaled, SLA violation may not occur.

Further, referring to FIG. 6, in the case of traffic in which the volatility is significant like a NASA trace, upon stand-by without immediately increasing the resource quota, it is more effective, and the moderate setting value is satisfied at the 95%-tile level, and a slow setting value does not also significantly violate the service quality at the 95%-tile level. That is, it can be seen that by delaying the resource quota scaling time overall, resource efficiency is increased.

The auto scaling method according to an embodiment of the present disclosure may be implemented even in the form of a recording medium including an instruction executable by a computer such as an application or a program module executed by the computer. A computer readable medium may be a predetermined available medium accessible by the computer, and includes all of volatile and non-volatile media, and removable and irremovable media. Further, the computer readable medium may include computer storage media. The computer storage media include all of the volatile and non-volatile, and removable and irremovable media implemented by a predetermined method or technology for storing information such as a computer readable instruction, a data structure, a program module, or other data.

The above-described auto scaling method may be executed by an application (this may include a program included in a platform or an operating system basically mounted on a terminal) basically installed in the terminal, and may be also executed by an application (i.e., program) which the user directly installs in an application providing server such as an application store server, a web server related to an application or the corresponding service, etc. In this sense, the auto scaling method may be implemented by the application (i.e., program) basically installed in the terminal or directly installed by a user, and recorded in the computer readable recording medium such as the terminal.

The embodiment of the present disclosure is disclosed for the purpose of exemplification and those skilled in the art will be able to make various modifications, changes, and additions within the spirit and scope of the present disclosure, and such modifications, changes, and additions should be considered as falling within the scope of the following claims.

What is claimed is:

1. An auto scaling device considering an application response time, comprising:
a processor; and
a memory connected to the processor,
wherein the memory stores program instructions executed by the processor to
restrict resources of pods distributed according to setting of an initial resource quota in a name space,
collect a monitoring metric of an application for which service is requested,
determine whether to change a resource quota by using the collected monitoring metric, a recent data reflection rate of a service predetermined in a custom resource, a service level agreement (SLA) of a service, and an SLA threshold when the resources of pods are insufficient, and
update the initial resource quota in the name space to a first resource quota when the change of the resource quota is required.

2. The auto scaling device of claim 1, wherein the program instructions calculate a calculation value of the application response time by using the collected monitoring metric and the recent data reflection rate at a predetermined cycle.

3. The auto scaling device of claim 1, wherein the recent data reflection rate is classified into multiple levels.

4. The auto scaling device of claim 1, wherein the recent data reflection rate is classified into immediate, moderate, slow, and very slow in an order of high recent data reflection rate.

5. The auto scaling device of claim 2, wherein the program instructions determine that the initial resource quota is updated to the first resource quota when an alarm is generated due to the insufficient resources of pods, and the calculation value of the application response time calculated through a predetermined prediction model exceeds a result of summing up the SLA and a value acquired by multiplying the SLA by the SLA threshold.

6. The auto scaling device of claim 5, wherein the calculation value of the application response time is a weighted moving average of the application response time calculated by using an exponential weighted moving average (EWMA) model at a predetermined cycle.

7. The auto scaling device of claim 6, wherein the weighted moving average of the application response time is calculated by an equation below:
$${\overline{x}}_{k} = α {\overline{x}}_{k - 1} + ( 1 - α ) {x}_{{k}_{( 0 < α < 1 )}} \qquad [ Equation ]$$
wherein, xₖ represents a current response time, x̅ₖ₋₁ represents a moving average value up to a previous sample, α represents the recent data reflection rate, and x̅ₖ represents a weighted moving average up to a current sample.

8. The auto scaling device of claim 1, wherein computing resource information of pods is collected through a metric server, and
the computing resource information includes a target central processing unit (CPU) utilization, a number of currently distributed pods, and a CPU usage of a current pod.

9. The auto scaling device of claim 8, wherein the first resource quota is calculated by an equation below:
$$cur Quota = reqPods * ceil \{ ( cur Utilization Val - curHPA ) * cPods \} \qquad [ Equation ]$$
wherein, curQuota represents a resource quota value updated by an auto scaling, reqPods represents a requested central processing unit (CPU) specification of application pods, curUtilizaionVal represents the CPU usage of the current pod, curHPA represents a target CPU utilization of a horizontal pod autoscaler (HPA), and cPods represents the number of currently distributed pods.

10. The auto scaling device of claim 1, wherein the program instructions update the first resource quota to the initial resource quota again when a pod error is removed due to the update to the first resource quota.

11. An auto scaling device considering an application response time, comprising:
a processor; and
a memory connected to the processor,
wherein the memory stores program instructions executed by the processor to
restrict resources of pods distributed according to setting of an initial resource quota in a name space,
collect a monitoring metric of an application for which service is requested, and
delay scaling by using at least one of the collected monitoring metric, a recent data reflection rate of a service predetermined in a custom resource, a service level agreement (SLA) of a service, and an SLA threshold when the resources of pods are insufficient.

12. An auto scaling system considering an application response time, comprising:
a cluster manager restricting resources of pods distributed according to setting of an initial resource quota in a name space;
an application monitoring unit collecting a monitoring metric of an application for which service is requested; and
a custom scaling controller determining whether to change a resource quota by using the collected monitoring metric, a recent data reflection rate of a service predetermined in a custom resource, a service level agreement (SLA) of a service, and an SLA threshold when the resources of pods are insufficient, and updating the initial resource quota in the name space to a first resource quota when the change of the resource quota is required.

13. An auto scaling method considering an application response time in a device including a processor and a memory, the method comprising:
restricting resources of pods distributed according to setting of an initial resource quota in a name space;
collecting a monitoring metric of an application for which service is requested;
determining whether to change a resource quota by using the collected monitoring metric, a recent data reflection rate of a service predetermined in a custom resource, a service level agreement (SLA) of a service, and an SLA threshold when the resources of pods are insufficient; and
updating the initial resource quota in the name space to a first resource quota when the change of the resource quota is required.

14. The auto scaling method of claim 13, wherein the determining whether to change the resource quota includes:
calculating a calculation value of the application response time by using the collected monitoring metric and the recent data reflection rate at a predetermined cycle.

15. The auto scaling method of claim 13, wherein the recent data reflection rate is classified into multiple levels.

16. The auto scaling method of claim 13, wherein the recent data reflection rate is classified into immediate, moderate, slow, and very slow in order of high recent data reflection rate.

17. The auto scaling method of claim 14, wherein in the determining whether to change the resource quota, it is determined that the initial resource quota is updated to the first resource quota when an alarm is generated due to the insufficient resources of pods, and the calculation value of the application response time calculated through a predetermined prediction model exceeds a value acquired by summing up the SLA and a value acquired by multiplying the SLA by the SLA threshold.

18. The auto scaling method of claim 17, wherein the calculation value of the application response time is a weighted moving average of the application response time calculated by using an exponential weighted moving average (EWMA) model at the predetermined cycle.

19. The auto scaling method of claim 18, wherein the weighted moving average of the application response time is calculated by an equation below:
$${\overline{x}}_{k} = α {\overline{x}}_{k - 1} + ( 1 - α ) {x}_{{k}_{( 0 < α < 1 )}}$$
wherein, xₖ represents a current response time, x̅ₖ₋₁ represents a moving average value up to a previous sample, α represents the recent data reflection rate, and x̅ₖ represents a weighted moving average up to a current sample.

20. The auto scaling method of claim 13, wherein computing resource information of pods is collected through a metric server,
the computing resource information includes a target central processing unit (CPU) utilization, a number of currently distributed pods, and a CPU usage of a current pod, and
the first resource quota is calculated by an equation below:
$$cur Quota = reqPods * ceil \{ ( cur Utilization Val - curHPA ) * cPods \} \qquad [ Equation ]$$
wherein, curQuota represents a resource quota value updated by the auto scaling, reqPods represents a requested CPU specification of application pods, curUtilizaionVal represents the CPU usage of the current pod, curHPA represents a target CPU utilization of a horizontal pod autoscaler (HPA), and cPods represents the number of currently distributed pods.
